(19) United States
(12) Patent Application Publication
(10) Pub. No.: US 2010/0294608 A1
(43) Pub. Date: Nov. 25, 2010

(54) Torque/rotational speed differential-dependent coupling actuation unit for engine-driven vehicles

(75) Inventors: Helmut Städele, Spaichingen (DE); Ingo Dreher, Balgheim (DE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Dreher Prazisionsdrehteile GmbH, Balgheim (DE)

(21) Appl. No.: 12/597,399

(22) PCT Filed: Mar. 5, 2008
(86) PCT No.: PCT/EP08/01752

§ 371 Date: Jun. 30, 2010

(30) Foreign Application Priority Data
Apr. 24, 2007 (DE) 20 2007 005 899.3

(51) Int. Cl. F16D 41/18; F16D 43/20

(52) U.S. Cl. 192/54.1

(57) ABSTRACT

The invention relates to a clutch operating unit for engine-driven vehicles, the clutch of which can be operated arbitrarily as well as depending on a torque/speed difference occurring at the clutch. The clutch operating unit comprises an actuator on the gear box side and the engine side. On the actuator, chutes and counter chutes and contact surfaces are formed which mutually engage; the chutes, counter chutes and contact surfaces transmitting a drive torque when the actuators are rotated in a rotating direction over the contact surfaces and, when the actuators are rotated in reverse rotating direction, converting the rotating movement into an axial movement of an actuator by means of the chutes and counter chutes, the axial movement effecting the releasing of the clutch. The clutch operating unit is characterized in that the actuator (2, 5) on the engine side along with its outer bushing is arranged coaxially and rotatably relative to a gear box input shaft. Additionally, the actuator (2, 5) on the engine side along with its outer bushing (is arranged slidably relative to the gear box input shaft wherein its slidability towards the gear box housing is limited by a stop (3). The actuator (1) on the gear box side is arranged coaxially relative to and in circumferential direction force- and/or form-fittedly, but axially slidably on the gear box input shaft having outer teething, wherein the actuator's slidability in the direction towards the gear box housing is limited by the actuator (2) on the engine side and/or a stop.

### CROSS-REFERENCE TO RELATED APPLICATION

This Application is a Section 371 National Stage Application of International Application No. PCT/EP2008/001752, filed 5 Mar. 2008 and published as WO 2008/128599 on 30 Oct. 2008, the content of which is hereby incorporated by reference in its entirety.

### BACKGROUND OF THE INVENTION

The invention relates to a clutch operating means for engine-operated vehicles, the clutch of which can be operated arbitrarily as well as depending on a torque/speed difference occurring at the clutch. In a vehicle, e.g. a truck, car, tricycle, quad or a motorbike, an engine, e.g. a combustion engine and/or an electro-motor and/or a liquid motor or the like, generates a driving torque which is used for moving the vehicle by means of a suitable drive chain. The drive chain usually comprises a clutch, e.g. a friction clutch, which is arranged behind the engine. In the direction of the force flow, a gear box follows the exit torque of which is transmitted to one or more drive wheels, if need be by interposing a differential gear or a chain or universal drive.

When the driving power of a vehicle equipped suchlike is reduced (overrun condition) the engine generates a negative driving torque (brake torque) which is transmitted to the drive wheels via the drive chain. This is referred to as engine brake or engine braking effect. On even ground, the inertia of the vehicle causes the vehicle-slowing down- to move further. Thereby the flow direction of the forces reverses as the drive wheels have a driving effect on the engine now. When the vehicle is changed down by one or more gears in this driving condition, this may result in occasionally high speed increase of the gear box input shaft caused by the drive wheels. Thus, there is the risk that the maximum engine speed is exceeded as soon as the force flow is recovered when closing the clutch. This can occasionally result in damaging or destroying the engine. A short-term blocking of the drive wheels is also possible and can result in an instable drive condition.

In order to avoid this, particularly for motorbikes a clutch technology is known which is referred to as anti-hopping clutch or slipper clutch. The anti-hopping clutch allows the rapid, almost brake-free down shifting without the typical rear wheel stamping which is caused by a short blocking of the rear wheel. The anti-hopping clutch interrupts the force flow, ideally before the drive wheel blocks, at the clutch. Here, a predetermined torque/speed difference between the brake force of the engine and the drive torque of the driving drive wheels in overrun condition leads to an opening of the clutch or an increase in the slip of the clutch. The brake torque of the engine is exerted on the part of the clutch which is connected to the engine, e.g. the clutch housing. The drive wheel torque driving in the overrun condition is exerted on the clutch part which is connected to the gear box input shaft, e.g. the clutch hub or disk. Thereby, the interrupting of the force flow by the clutch is performed without any action by the driver. The effect of the interrupting of the force flow is similar to a free wheel since the transmission of a drive torque is only possible in one direction, namely from the engine to the drive wheels. When the torque/speed difference at the clutch decreases against 0, e.g. by accelerating the engine again or a sufficient slowing down of the drive wheel(s), the clutch engages again and reestablishes the force flow.

Such an anti-hopping clutch interrupting the force flow is known from EP-B1-0 854 304. Between a rotation-symmetrical clutch cage connected to the crankshaft of the engine and a rotation-symmetrical clutch hub connected to the gear box input shaft, clutch plates being teethed on the inner or outer side are alternatingly arranged; said clutch plates are compressed in a generally known manner by a clutch pressure plate when closing the clutch. The clutch hub used here has two parts and is arranged within the clutch cage. The inner part of the clutch hub can be rotated relative to the outer part to a limited extent. From a certain torque difference between the input and the output of the clutch, the relative rotation of the inner part of the hub in combination with chutes and counter chutes, between which a ball is guided, causes a limited axial movement of the inner part in the direction towards the clutch pressure plate. The inner part of the clutch hub exerts a certain release force onto the clutch pressure plate caused by this axial movement, the release force causing the clutch to slip up to the entire interrupting of the force flow dependent on the torque. The balls guided between the chutes and counter-chutes effect a low, reproducible breakaway torque which prevents a abrupt releasing and re-engaging of the clutch. The desired characteristic of the anti-hopping clutch can be adjusted by selecting the pitch of the chutes; the characteristic can depend on, e.g., the maximum speed of the engine.

A similar rotation symmetric clutch is known from WO 98/40638 A1. In this clutch, the clutch hub being arranged within the clutch cage has three parts. Here an intermediate hub part having the clutch plates in its interior is arranged force- and form-fit between two further hub parts which can comprise respective chutes and counter-chutes and balls guided therebetween. In order to adjust the initial torque/speed difference from which the inner part of the clutch hub should start a relative movement relative to the intermediate and outer part, all parts of the clutch hub are biased against each other by a screw spring. Additionally a radial ball bearing is arranged on the inner part of the clutch hub, the outer cap of the radial ball bearing is supported against a central part of the clutch adjusting spring when the clutch is released depending on the torque.

It is the essential similarity of the two described clutch operating constructions that the input and output of the clutches in which they can be used inevitably have a difference in diameter between the input and output, said difference being caused by the clutch plates being engaged alternatingly at the inner and outer side. Furthermore the input and output of the two known clutches is performed only from one side, i.e., engine and gear box are arranged on the same side of the clutch. Thus, using this clutch operating construction is only possible for certain clutches and for certain arrangements of the entire parts of the drive chain. It is particularly limited to an arrangement in which the rotation axes of the crankshaft and the gear box input shaft have a parallel offset wherein the interposing of a primary drive is obligatory. The primary drive can either be arranged between the crankshaft and the clutch or between clutch and gear box input shaft. Frequently, the primary drive also has a transmission for reducing the crankshaft speed to a lower speed of the gear box input shaft. Such an arrangement is typical for vehicles in which the drive is arranged transversal to the longitudinal axis of the vehicle.

In another conventional drive chain concept, the drive speed of the engine and of the gear box input shaft are identical, i.e. in this case there is no primary transmission. In this case, the middle lines of crankshaft, clutch and gear box input shaft fall in one line so that a primary drive is dispensable. There is no parallel offset between them but they are arranged one after the other in one line, i.e., the engine is arranged on one side of the clutch and the gear box is arranged on the other side of the clutch. Such arrangements of drive, clutch and gear box one after the other are particularly present in vehicles in which the crankshaft of the engine is oriented along the longitudinal direction of the vehicles. For such drive chain concepts, the above described anti-hopping clutches are not suitable.

Thus it is an object of the present invention to suggest a constructively simple solution which can also be backfitted for a torque/speed difference dependent clutch operating means for those engine-operated vehicles in which the engine, the clutch and the gear box input shaft are arranged one after the other (in series) so that their rotational axes fall in one line.

The object is solved by the invention in that a clutch operating device is configured with the features according to claim 1. Advantageous embodiments are subject-matters of the subclaims.

Besides the simple constructive structure and the low volume, it is assumed to be a particular advantage of the solution according to the present invention that it can be pre-assembled as an entire unit and can be easily exchanged against present clutch elements.

### BRIEF DESCRIPTION OF THE DRAWINGS

In the following, the invention is explained by the embodiments shown in the drawing.

FIG. 1 shows a cross-section of a first clutch operating unit.

FIG. 2 shows an exploded view of the first clutch operating unit.

FIG. 3 shows a view of the actuator on the engine side.

FIG. 4 shows a view of the actuator on the side of the gear box.

FIG. 5 shows a cross-section of a second clutch operating unit, and

FIG. 6 shows an exploded view of the second clutch operating unit.

### DETAILED DESCRIPTION OF ILLUSTRATIVE EMBODIMENTS

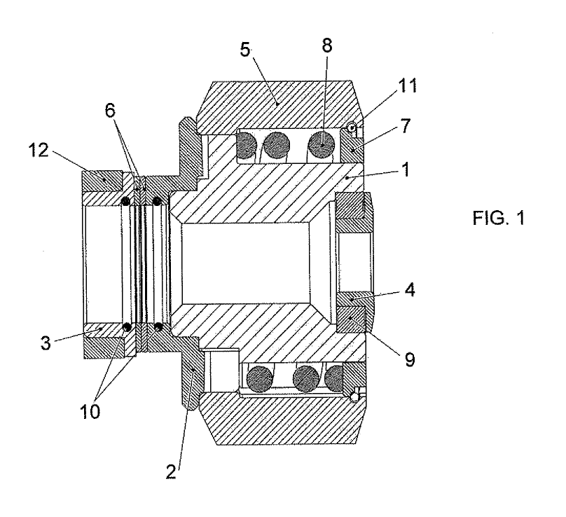

The first embodiment according to the present invention shown in FIG. 1 is arranged for example on a not shown gear box input shaft which extends from the left hand side in FIG. 1 into the actuator 1 of the clutch operating unit on the gear box side. The right side in FIG. 1 of the clutch operating unit is oriented towards the engine. The actuator 1 on the gear box side is adapted to the configuration of the inner circumference of the gear box input shaft, e.g. by a respective keyseat teething or the like, so that it is attached to the gear box input shaft in a force- and form-fit manner in the circumferential direction but slidably in axial direction when it is mounted. Furthermore, the clutch operating unit comprises an actuator 2 on the engine side. Actuator 2 is supported axially through a rotation-symmetric shoulder against a respective shoulder 21 at the end of actuator 1 on the gear box side. According to the embodiment, actuator 2 is connected in a rotatably fixed manner to an outer bushing 5. The connection of the actuator 2 and the outer bushing 5 can be performed in a force- and form-fit manner and/or by material. For example, in actuator 2 boreholes 17 can be provided through which bolts or screws can be put in order to establish a rotatably fix connection to the outer bushing 5. The two-part design of actuator 2 on the engine side and the outer bushing 5 according to the embodiment only has production-related reasons but no functional reasons. Thus, actuator 2 and outer bushing 5 can also be performed integrally. With outer bushing 5, for example a not shown clutch lining carrier is mounted in a rotatably fix manner. Between the outer circumference of actuator 1 on the gearbox side and the inner circumference of outer bushing 5, a ring groove for receiving a suitable spring element, for example a spiral spring 8, a disk spring, a rubber spring or the like is provided. The spring element is biasedly mounted in the ring groove and is supported at one end at an outer collar of actuator 1 on the gear box side. At its other end, the spring element is supported by a support element, e.g. a circular spring lock 7, the support element being axially secured by a locking ring 11 at the inner circumference of outer bushing 5.

On the side facing the engine of actuator 1 an axial ball bearing 9 is supported, the outer bearing cup of which facing away from actuator 1 is configured as contact surface for a clutch spring, a clutch spring carrying element, a clutch release bearing or the like. As shown in the embodiment, a separate component in form of a spring pusher 4 can be provided on the outer bearing cap therefore.

On the side of the clutch operating unit facing the gear box opposite to the (not shown) bearing ring of the gear box input shaft, an axial support of the front surface of actuator 2 on the engine side is provided. Therefore a circular bearing stop 3 is configured such that it can be arranged rotatably on the inner circumference in contact with the inner bearing ring on the gear box input shaft. On the outer circumference of bearing stop 3 a radial shaft sealing ring 12 is arranged, said radial shaft sealing ring serving, when necessary, as sealing between gear box housing and gear box input shaft. Also for this purpose serves, when necessary, another sealing means on the inner circumference of bearing stop 3, for example, this further sealing means can be an O-ring or the like being provided in a respective ring groove of the bearing stop 3. Additionally, a further O-ring 10 can be provided in a ring groove at the inner circumference of actuator 2 on the engine side, when necessary. The sealing of the gear box input shaft against the gear box housing in constructive unity with the bearing stop 3 is only an advantageous embodiment. For the function of the clutch operating unit, sealing of the gear box is not necessary. Therefore, the sealing of the gear box can also be achieved by other constructive measures, for example a sealed bearing unit, as long as the support of the clutch operating unit is guaranteed on the gear box input side.

On the front surface between bearing stop 3 and actuator 2, there is/are provided one or more starting disk(s) 6. They serve to uncouple the rotation between the actuator 2 and the bearing stop 3. Simultaneously, an exact adjusting of the position of the clutch operating unit in axial direction on the gear box input shaft can be achieved by means of the starting disk(s).

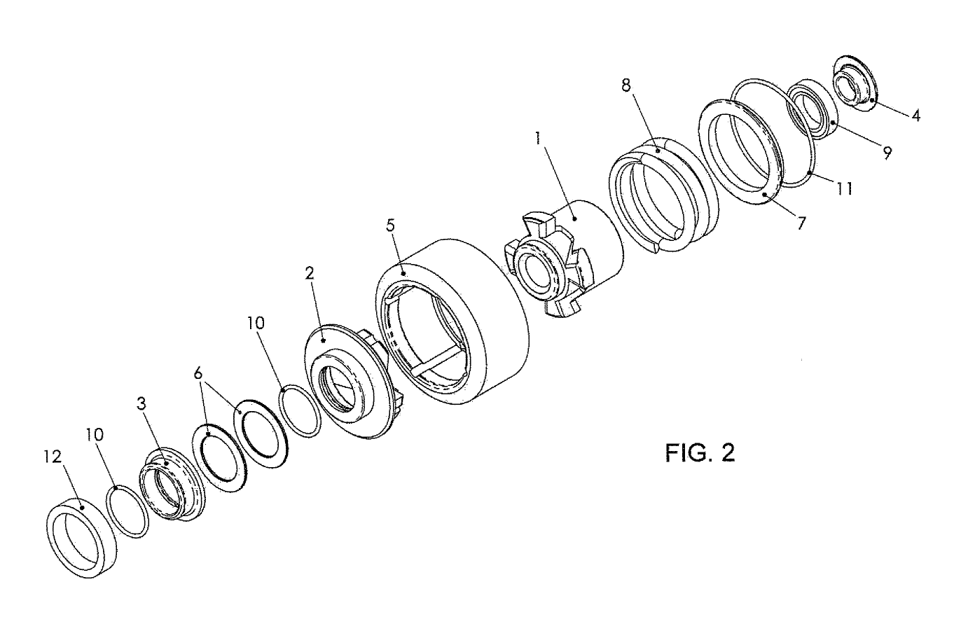

From the exploded view of the clutch operating unit according to the present invention in FIG. 2, the sequence of the components when assembling as well as their arrangement on the not shown gear box input shaft. Therefrom, it can also be taken that the entire clutch operating unit can be pre-assembled. Thereby, a clutch lining carrier can be attached to the outer bushing 5 in a particularly advantageous manner. In this case the backfitting of a vehicle with a clutch operating unit according to the present invention is particularly easy since only the present clutch lining carrier has to be replaced. Usually, there is no need for constructive changes at the gear box or the clutch.

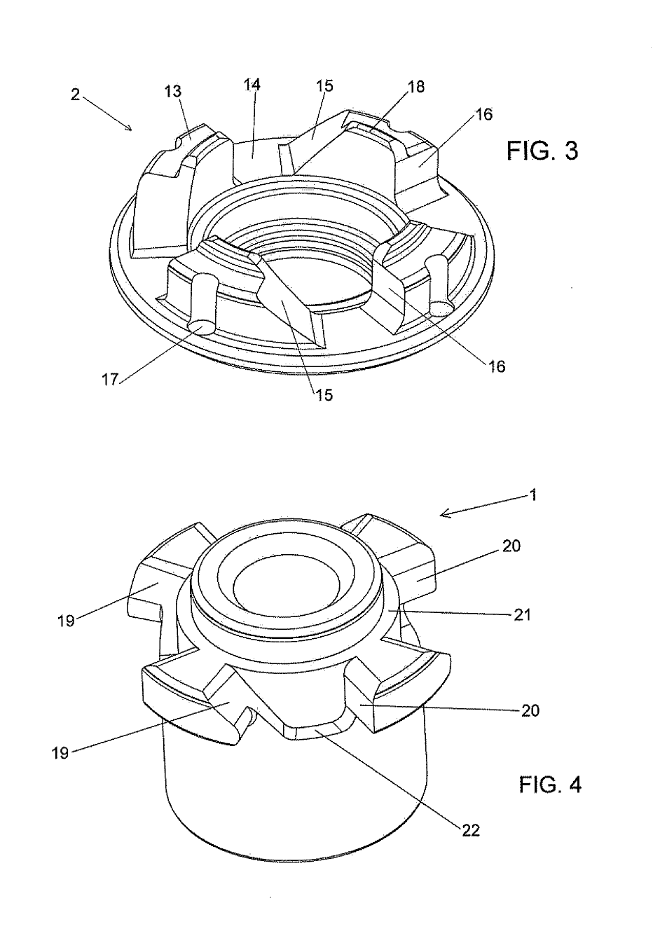

FIGS. 3 and 4 show views of the two actuators 1 and 2 from which their co-operation become obvious. On the actuator 2 on the engine side, segmentlike projections 13 and recesses 14, preferably 4 of each, are arranged circularly. When mounted, the projections 13 engage with respective recesses of the actuator 1 on the side of the gear box, like a spur gearing as shown in FIG. 1. At the end in circumferential direction of each projection 13 of the actuator 2 a chute 15 is formed, at each other end a contact surface 16 extending radially and axially. The chutes 15 and the contact surfaces 16 can be provided with a radius on the head and bottom side as shown in FIG. 3. Respective counter chutes 19 and counter contact surfaces 20 are formed at the collar of the actuator 1 on the gear box side, see FIG. 4. The chutes and counter chutes 19 as well as the contact and counter contact surfaces 16, 20 have the effect that a drive torque can only be transmitted in one rotation direction over the spurgear-like connection, namely when the substantially axial contact surfaces 16, 20 of the two actuators 1, 2 contact each other. This is the case when a torque is transmitted from the engine to the gear box input shaft over the closed clutch. In overdrive condition or when shifted down, as soon as the speed of the gear box input shaft exceeds the drive speed, the two substantially axial contact surfaces 16, 20 release each other and instead chutes 15, 19 come into contact. With a further relative rotation of the two actuators 1, 2 the chutes 15, 19 slide on each other. As the actuator 2 on the engine side is supported at the gear box in axial direction, the actuator 1 on the gear box side is axially moved against the force of the spring element 8 in the direction of the engine side by the relative rotation. During this axial movement the bearing 9 having effect in axial direction or the spring pusher 4 comes into contact with the clutch spring, the clutch spring carrying component, the clutch release bearing or the like, thus the clutch starts slipping or releases and interrupts the force flow.

On the projections 13 of the actuator 2 on the engine side circular guide ridges 18 can be formed. In this case, guide grooves 22 are provided on the actuator 2 on the gear box side, the guide ridges 18 engage with the guide grooves when the clutch operating unit is inactive.

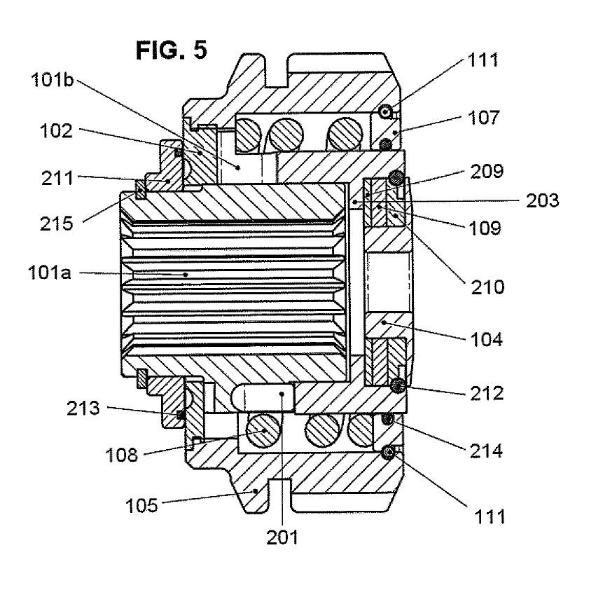

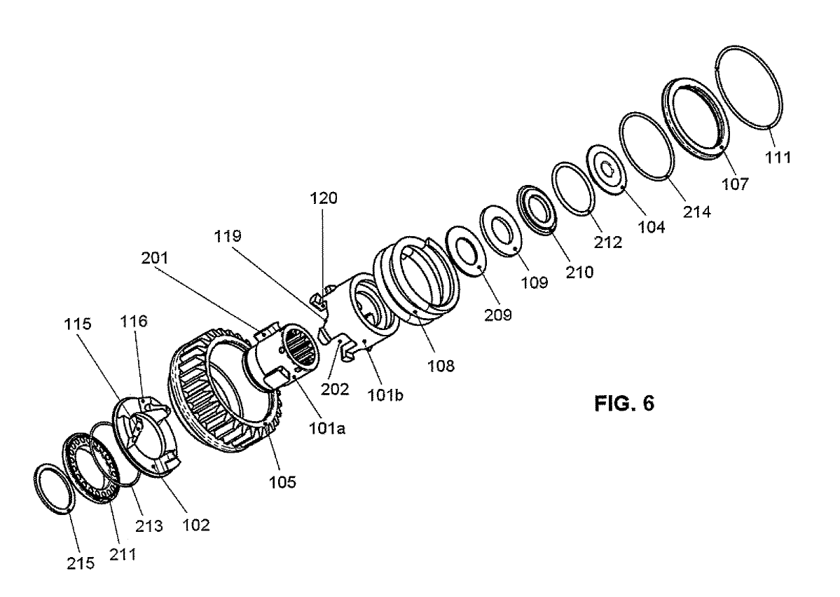

FIGS. 5 and 6 show a second embodiment of a clutch operating unit according to the present invention. The way of functioning generally corresponds to the one of the first embodiment described above in detail. Particularly, said clutch operating unit directly transmits a torque to the gear box input shaft, said torque being generated by the engine and transmitted over the clutch lining carrier when the clutch is closed. When, however, the engine is running in the engine brake operation and prevails thereby the torque generated by the rear wheel or wheels at the gear box input shaft, the clutch operating unit opens the clutch automatically and interrupts the force flow between engine and gear box.

The second embodiment differs from the first embodiment in that securing the position of the clutch operating unit on the gear box input shaft by means of a shaft bushing 101a of a two-part actuator 101 on the gear box side is constructively performed in another way. Shaft bushing 101a comprises an inner teething which is adapted to the outer teething of the gear box input shaft also in the longitudinal extension thereof. Particularly, the inner teething of the shaft bushing 101a extends from the end on the gear box side of the outer teething of the gear box input shaft to about the end of the gear box input shaft on the engine side, said end of the teething regularly has a sufficient distance to the shaft sealing ring of the gear box housing. Thus, the slidability of the shaft bushing 101a in the direction of the gear box is limited by the contacting ends of the shaft- and bushing teething. Additionally or alternatively, a not shown axial support disk can be integrated into the shaft bushing 101a, said axial support disk limiting the axial displacement of the shaft bushing 101a in the direction of the gear box housing on the gear box input shaft. For this purpose, also the use of an inner retaining ring is also possible. Thereby, in an advantageous manner a simple support of the entire clutch operating unit by means of the shaft bushing 101a on the gear box input shaft is achieved in each case, said shaft bushing replacing the necessary bearing stop 3 of the first embodiment.

On the outer circumference of the shaft bushing 101a, preferably three outwardly oriented torque transmitting projections 201 are evenly arranged. Each of said projections 201 engage with corresponding recesses 202 of an inner bushing 101b, which forms the second part of the actuator 101 on the side of the gearbox. The mutual contact surfaces of the projections 201 and the recesses 202 of the inner bushing 101b are preferably provided friction-reducing coating or guide grooves for receiving bearing balls, thereby reducing the breakaway torque of the clutch operating unit in a known manner.

As shown in FIG. 5, the inner bushing 101b is arranged axially slidably and rotatably on a part of the outer circumference of the shaft bushing 101a. In the end of the engine side of inner bushing 101b a spring pusher 104 which has direct effect on the not shown clutch pressure spring, is supported by means of an axial bearing unit comprising a bearing stop 210, an axial bearing 109 and a starter disk 209. Spring pusher 104 is connected to the bearing stop 210 by means of a press fit. The axial bearing unit is axially fixed between a circumferential inner ridge 203 of the inner bushing 101b and an O-ring 212 in the inner bushing 101b. When assembled, the O-ring 212 is hold by a respective semi-circular recess near the end of the inner bushing 101b on the engine side and a quadrant-circular recess on the outer circumference of the bearing stop 210. Thus, the cross-section of the O-ring 212 is enclosed over three-fourth of its circumference by inner bushing 101b and bearing stop 210.

The actuator 101 on the gear box side formed in two parts considerably facilitates the axial movement necessary for operating the clutch since the shaft bushing 101a form-fit connected to the gear box input shaft over a shaft teething remains at its relative position to the gear box input shaft and the clutch releasing axial movement—a sufficient difference in torque or speed provided—is performed only by the entire inner bushing 101b.

At its end on the gear box side the shaft bushing 101a preferably comprises three further recesses with counter chutes 119 and counter contacting surfaces 120, which co-operate with chutes 115 and contact surfaces 116 of an actuator 102 on the engine side in the above described manner. Here, friction-reducing coatings or guide grooves for receiving bearing balls can be arranged between the chutes 115 and the counter chutes 119, which reduce the breakaway torque of the clutch operating device in a generally known manner.

The actuator 102 on the engine side is connected with an outer bushing 105 having outer teething to form a unit, preferably both components are pinned and/or welded to each other. Into the outer teething of the outer bushing 105, a clutch lining carrier having a corresponding outer teething engages in each rotation direction force-fittingly and in the teething axially slidingly. Since such a clutch lining carrier, particularly for liquid-free clutches having one disk, is sufficiently known, it is refrained from providing a Figure and description thereof at this point. The rotatable support of the actuator 102 on the engine side is provided on the outer circumference of the shaft bushing 101a and particularly near the shaft bushing's end on the gear box side, as shown in FIG. 5. There, the actuator 102 on the engine side is supported against an axial movement towards the gear box in a circular start bearing 211. The starter bearing in turn is held by a retaining ring 215 which is inserted into a respective groove of the shaft bushing 101a.

The remaining ridges between the six recesses of the inner bushing 101b are cranked radially outwards, as shown in FIG. 6. A biased spiral spring 108 works against the cranks of the inner bushing 101b, said spiral spring being supported with its other end by a spring lock 107 which is held by a securing ring 111 in the interior of the end on the engine side of the outer bushing 105. Thus, it is guaranteed that axially displacable inner bushing 101b returns to its start position as soon as the torque or speed difference between the engine and the gear box input shaft arrives at a minimum. By a suitable dimensioning of spiral spring 108 the response behavior of the clutch operating unit can be determined as well as by the selection of the pitch of chutes 115 and counter chutes 119.

In order to prevent the entrance of dust, clutch wear etc. which could constrain the rotational and axial movement of the inner bushing 101b, the spring lock 107 is sealed against the inner bushing 101b by an O-ring 214. For the same reason, another O-ring 213 can also be arranged between the actuator 102 on the gear box side and the starter bearing 211. Said O-ring is particularly advantageous when a ball- or needle containing axial bearing is provided between the actuator 102 on the gear box side and the starter bearing 211.

The above described clutch operating unit is particularly suitable for being used in vehicles having a liquid-free clutch with one disk and a clutch pressure spring being formed as a disk spring, wherein the disk spring is preferably operated by a clutch pressure rod which is guided through a hollow drilled gear box input shaft: Thereby, the clutch operating unit according to the present invention is centrally coupled to the clutch lining carrier.

Although the present invention has been described with reference to preferred embodiments, workers skilled in the art will recognize that changes may be made in form and detail without departing from the spirit and scope of the invention.

1. A clutch operating unit for engine-driven vehicles, the clutch of which can be operated arbitrarily as well as depending on a torque/speed difference occurring at the clutch, comprising an actuator on the gear box side and on the engine side, wherein chutes and counter chutes and contact surfaces which engage with each other are formed at the actuators, the chutes, counter chutes and contact surfaces transmitting a drive torque when the actuators are rotated in a rotating direction over the contact surfaces and, when the actuators are rotated in reverse rotating direction, converting the rotating movement into an axial movement of an actuator by means of the chutes and counter chutes, the axial movement effecting the releasing of the clutch, characterized in that the actuator on the engine side along with its outer bushing is arranged coaxially and rotatably relative to a gear box input shaft, the actuator on the engine side along with its outer bushing is arranged slidably in axial direction relative to the gear box input shaft, wherein its slidability in the direction of the gear box housing is limited by a stop, and the actuator on the gear box side is arranged coaxially relative to and in circumferential direction force- and/or form-fittedly, but axially slidably on the gear box input shaft having outer teething, wherein the actuator's slidability in the direction towards the gear box housing is limited by the actuator on the engine side and/or a stop.

2. The clutch operating unit according to claim 1, characterized in that at least a part of the actuator on the engine side along with its outer bushing encloses the actuator on the gear box side at its outer circumference, that at least a part of the front surface facing the engine of the actuator on the gear box side is formed as contact surface with a clutch spring, a clutch spring carrying element, a clutch pressure plate or a clutch release bearing.

3. The clutch operating unit according to claim 1, characterized in that the actuator on the engine side is formed by two elements being connected to each other rotatably fix in a force and form-fit manner and/or by material, wherein the chutes and the contact surfaces are formed at the actuator and the second element is formed as outer bushing enclosing the actuator at its outer circumference.

4. The clutch operating unit according to claim 1, characterized in that one ball at a time is arranged between the chutes and the counter chutes, the balls being force guided in grooves of the chutes and the counter chutes.

5. The clutch operating unit according to claim 1, characterized in that the actuator on the engine side and the outer bushing are integrally formed.

6. The clutch operating unit according to claim 1, characterized in that a bearing stop is provided for supporting the actuator on the engine side against the gear box housing, the bearing stop being rotatably arranged on the gear box input shaft and being in direct contact with the bearing inner ring of the bearing of the gear box input shaft.

7. The clutch operating unit according to claim 6, characterized in that a radial shaft sealing ring is arranged on the outer circumference of the bearing stop, said radial shaft sealing ring sealing the gear box housing against the clutch housing.

8. The clutch operating unit according to claim 6, characterized in that a radial sealing is arranged at the inner circumferential surface of the bearing stop, the radial sealing sealing the gear box housing against the clutch housing.

9. The clutch operating unit according to claim 1, characterized in that one or more starter disks are arranged on the gear box input shaft between the actuator of the engine side and the bearing stop.

10. The clutch operating unit according to claim 1, characterized in that the actuator on the gear box side is biased in axial direction against the actuator on the engine side by an elastic element.

11. The clutch operating unit according to claim 1, characterized in that the actuator on the engine side or its outer bushing (5, 105) is connected in a rotatably fix manner to a clutch lining carrier.

12. The clutch operating unit according to claim 11, characterized in that the rotatably fix connection is formed by a teething of the actuator on the engine side or its outer bushing and the clutch lining carrier.

13. The clutch operating unit according to claim 1, characterized in that a spring pusher as separate element is provided as contact surface of the actuator on the gear box side with the clutch spring, the clutch spring carrying element, the clutch pressure plate or the clutch releasing bearing.

14. The clutch operating unit according to claim 13 characterized in that a bearing is arranged between the actuator on the gear box side and the spring pusher.

15. The clutch operating unit according to claim 1, characterized in that the actuator on the gear box side is formed in two parts, comprising a shaft bushing having inner teething and being directly arranged on the gear box input shaft and an inner bushing which is arranged rotatably and axially slidably at the outside of the shaft bushing.

16. The clutch operating unit according to claim 1, characterized in that inner teething of the shaft bushing is adapted to the length of the outer teething of the gear box input shaft, so that the support of the shaft bushing is achieved by mutually contacting the ends of the two teethings when the end on the engine side of the shaft bushing is approximately in line with the end on the engine side of the gear box input shaft.

17. The clutch operating unit according to claim 15, characterized in that the spring pusher along with a respective bearing unit comprising a starter disk, an axial bearing and a bearing stop the bearing unit being arranged in the inner bushing.

18. The clutch operating unit according to claim 1, characterized in that a spiral spring is arranged biasedly between the inner bushing and the outer bushing enclosing the inner bushing.

19. The clutch operating unit according to claim 15, characterized in that the chutes of the actuator on the engine side and the counter chutes of the inner bushing comprise a friction-reducing surface coating or grooves in each of which a bearing ball is arranged.

20. The clutch operating unit according to claim 15, characterized in that the contact surfaces of the actuator on the engine side and the counter contact surfaces of the inner bushing co-operating therewith comprise a friction-reducing surface coating or grooves in each of which a bearing ball is arranged.
